(19) United States
(12) Patent Application Publication
(10) Pub. No.: US 2006/0238275 A1
(43) Pub. Date: Oct. 26, 2006

(54) Block filter

(75) Inventor: Stefan Burger, Reinstorf (DE)

Correspondence Address: NIXON & VANDERHYE, PC, 901 NORTH GLEBE ROAD, 11TH FLOOR, ARLINGTON, VA, 22203, US

(73) Assignee: Matsushita Electric Industrial Co., Ltd., Kadoma City (JP)

(21) Appl. No.: 11/406,495

(22) Filed: Apr. 19, 2006

(30) Foreign Application Priority Data
Apr. 20, 2005 (EP) 05008650.3

(51) Int. Cl. H01P 1/20

(52) U.S. Cl. 333/202

(57) ABSTRACT

The present invention relates to a method of constructing a microwave filter (1, 10) comprising a plurality of coupled resonators (2) and to a microwave filter manufactured by the method. A microwave filter (1, 10) is constructed by providing a plurality of individual resonators (2) and mechanically connecting the plurality of resonators (2) to form the filter (1, 10). Each of the resonators (2) is formed in one piece at least with a bottom wall (4) and a sidewall (5) laterally encircling the bottom wall (4) and extending upwardly therefrom. Furthermore, a plurality of coupling means (7, 11) is provided between the individual resonators (2). Accordingly, a microwave filter (1, 10) manufactured by the method comprises a plurality of coupled resonators (2) mechanically connected to form the filter (1, 10), wherein each of the plurality of resonators (2) is formed separately in one piece at least with a bottom wall (4) and a sidewall (5) laterally encircling the bottom wall (4) and extending upwardly therefrom, and wherein a plurality of coupling means (7, 11) is provided between the individual resonators (2).

This application is a new U.S. application claiming priority to EP 05008650.3 filed 20 Apr. 2005, the entire contents of which are hereby incorporated by reference.

The present invention relates to a method of constructing a microwave filter comprising a plurality of coupled resonators and to a microwave filter constructed in accordance with this method.

The microwave region of the electromagnetic spectrum finds widespread use in various fields of technology. Exemplary applications include wireless communication systems, such as mobile communication and satellite communication systems, as well as navigation and radar technology. The growing number of microwave applications increases the possibility of interference occurring within a system or between different systems. Therefore, the microwave region is divided into a plurality of distinct frequency bands. To ensure, that a particular device only communicates within the frequency band assigned to this device, microwave filters are utilized to perform band-pass and band reject functions during transmission and/or reception. Accordingly, the filters are used to separate the different frequency bands and to discriminate between wanted and unwanted signal frequencies so that the quality of the received and of the transmitted signals is largely governed by the characteristics of the filters. Commonly, the filters have to provide for a small bandwidth and a high filter quality.

For example, in communications networks based on cellular technology, such as the widely used GSM system, the coverage area is divided into a plurality of distinct cells. Each cell is assigned to a base station which comprises a transceiver that has to communicate simultaneously with a plurality of mobile devices located within its cell. This communication has to be handled with minimal interference. Therefore, the frequency range utilized for the communications signals associated with the cells are divided into a plurality of distinct frequency bands by the use of microwave filters. Due to the usually small size of the cells and the large number of mobile devices potentially located within a single cell at a time, the width of a particular band is chosen to be as small as possible. Moreover, the filters must have a high attenuation outside their pass-band and a low pass-band insertion loss in order to satisfy efficiency requirements and to preserve system sensitivity. Thus, such communication systems require an extremely high frequency selectivity in both the base stations and the mobile devices which often approaches the theoretical limit.

Commonly, microwave filters include a plurality of resonant sections which are coupled together in various configurations. Each resonant section constitutes a distinct resonator and usually comprises a space contained within a closed or substantially closed conducting surface. Upon suitable external excitation, an oscillating electromagnetic field may be maintained within this space. The resonant sections exhibit marked resonance effects and are characterized by the respective resonant frequency. In order for the filter to yield the desired filter characteristics, it is essential that the distinct resonators coupled together to form the filter have a predetermined resonant frequency. As the resonant frequency is largely determined by the size and shape of the resonator structure, the dimensions of a particular resonator have to be thoroughly calculated and the production process has to be carefully controlled.

For this reason, conventional microwave filters comprise a unitary metallic body including a plurality of recesses forming the resonant sections. A metallic cover plate is secured to the body to close the recesses. The process of manufacturing the filter body must accommodate precise dimensioning in order to obtain the desired filter characteristics. Typically, the body is formed by die-casting or by milling from a solid piece of metal. Such conventional microwave filters are relatively expensive to manufacture. For every filter, large amounts of material are required and it is always necessary to prepare a drawing and to manufacture the filter e.g. by milling from a block of metal. Further, it is not possible to change the filter characteristics without producing an entirely new filter panel. For example, many filter properties such as the number of poles, the selectivity and the insertion loss depend on the number of resonators used. Thus, conventional microwave filters do not provide for the highly desirable flexibility.

U.S. Pat. No. 4,034,319 discloses a microwave band-pass filter consisting of a plurality of resonator sections which are mechanically coupled together in series in a straight line. Each resonator section consists of a unitary metallic structure having four connected walls forming a hollow member of substantially rectangular cross-section providing two ground planes. Further, each resonator section includes a resonating bar integral with the hollow member and extending from one of the walls parallel to the ground planes. The individual resonator sections are coupled together by means of spacer sections. The width of each spacer section is chosen to control the spacing and thereby the coupling between adjacent resonating bars. While this filter provides for some degree of flexibility, the flexibility is nevertheless very limited and it is not possible to build complex filters. Further, it is difficult to choose the correct width of the spacer sections in order to achieve the desired results.

The object of the present invention is to provide a method for constructing a microwave filter having desired filter characteristics in a cost-efficient and flexible way and a microwave filter which may be constructed in a cost-efficient and flexible way.

This object is achieved by a method with the features of claim 1 and by a microwave filter with the features of claim 13. Further preferred embodiments of the invention are the subject-matter of the respective dependent claims.

According to the present invention, a microwave filter comprising a plurality of coupled resonators is constructed by providing a plurality of individual resonators and mechanically connecting the plurality of resonators to form the filter. Each of the resonators is formed in one piece or unitary at least with a bottom wall and a sidewall laterally encircling the bottom wall and extending upwardly therefrom. Accordingly, in the case of a rectangular bottom wall, there are four interconnected sidewalls, and in case of a circular bottom wall, the sidewall is cylindrical. Furthermore, a plurality of coupling means are provided between the individual resonators. This is done to couple the individual resonators together in the desired configuration. It is preferred that each of these coupling means is provided between two adjacent resonators. To form the filter, the resonators may be covered with individual cover plates or a common cover plate. The resonators may be placed on a plate, and coupling may be achieved by cutting openings into the sidewalls.

The method of the invention provides the advantage that a microwave filter with specific filter characteristics may be produced in a very flexible and cost-efficient way. It has been realized that the filter characteristics are largely governed by the dimensions of the individual resonators, and that the coupling between these resonators is less critical. Thus, a plurality of resonators, each closely meeting particular specifications, may be mechanically coupled together without impairing the desired filter performance. While it is difficult and expensive to manufacture a unitary filter body comprising a plurality of precisely dimensioned resonators, this is easily possible for individual resonators. Thus, it is easy to create in a short time filters and duplexers with different numbers of poles and with different configurations of coupled resonators. When it is necessary to increase the number of poles, a new resonator can be added. This provides for a high degree of flexibility.

In a preferred embodiment, the plurality of resonators includes coaxial resonators, dielectric resonators and/or cavity resonators. When using coaxial resonators, the inner conductor or post may be a separate component to be attached to the base wall. However, the inner conductor is preferably formed integrally with the base wall. In case of a dielectric resonator, a coaxial resonator with a low post height may be used to which the dielectric resonator is attached.

In a further preferred embodiment, one or more or all of the resonators of the plurality of resonators are formed by means of cold extrusion. In this way, the resonators can be precisely dimensioned while using a low amount of material, and may thus be produced in a particularly cost-efficient manner.

It is further preferred if the resonators are formed such that the thickness of the sidewalls is 0.5-0.8 mm. In this way, the amount of material used can be reduced in order to decrease the costs.

It is preferred if one or more or all of the resonators of the plurality of resonators are coated with a metallic conductor layer. In this case, the material for the walls of the resonator can advantageously be tailored to the manufacturing process. In case a high quality factor is required, the necessary high surface quality can be provided by the coating. A preferred coating is silver.

In a preferred embodiment, the coupling means include coupling loops, coupling irises, coupling windows and/or coupling probes. These can be chosen as required to provide inductive or capacitive coupling and to yield a desired coupling strength.

In a further preferred embodiment, the resonators are coupled in a two- or a three-dimensional array. In this way, complex filters can be made to provide specific filter characteristics.

Further, it is preferred if the resonators are coupled such that there is cross coupling between at least two of the resonators. This possibility is highly advantageous as many filter characteristics can only be obtained utilizing cross coupling.

The coupling means may be provided prior to or after mechanically connecting the resonators.

The resonators are preferably mechanically connected by soldering or brazing. In this way, the resonators can be readily connected and disconnected.

By means of the method of the invention, a microwave filter can be produced comprising a plurality of coupled resonators mechanically connected to form the filter, wherein each of the plurality of resonators is formed separately in one piece at least with a bottom wall and a sidewall laterally encircling the bottom wall and extending upwardly therefrom, and comprising a plurality of coupling means provided between the individual resonators.

In a preferred embodiment of the microwave filter of the invention, the plurality of resonators includes coaxial resonators, dielectric resonators and/or cavity resonators.

It is preferred that at least some resonators of the plurality of resonators are formed by means of cold extrusion.

It is further preferred if the thickness of the sidewalls of the resonators is 0.5-0.8 mm.

In a further preferred embodiment of the microwave filter of the invention, at least some resonators of the plurality of resonators are coated with a metallic conductor layer which is preferably a silver coating.

In a further preferred version of the microwave filter of the invention, the coupling means include coupling loops, coupling irises, coupling windows and/or coupling probes.

Further, it is preferred if the resonators are coupled in a two- or a three-dimensional array.

In a preferred embodiment of the microwave filter of the invention, the resonators are coupled such that there is cross coupling between at least two of the resonators.

The resonators are preferably mechanically connected by soldering or brazing.

In the following, the invention is explained in more detail for preferred embodiments with reference to the figures.

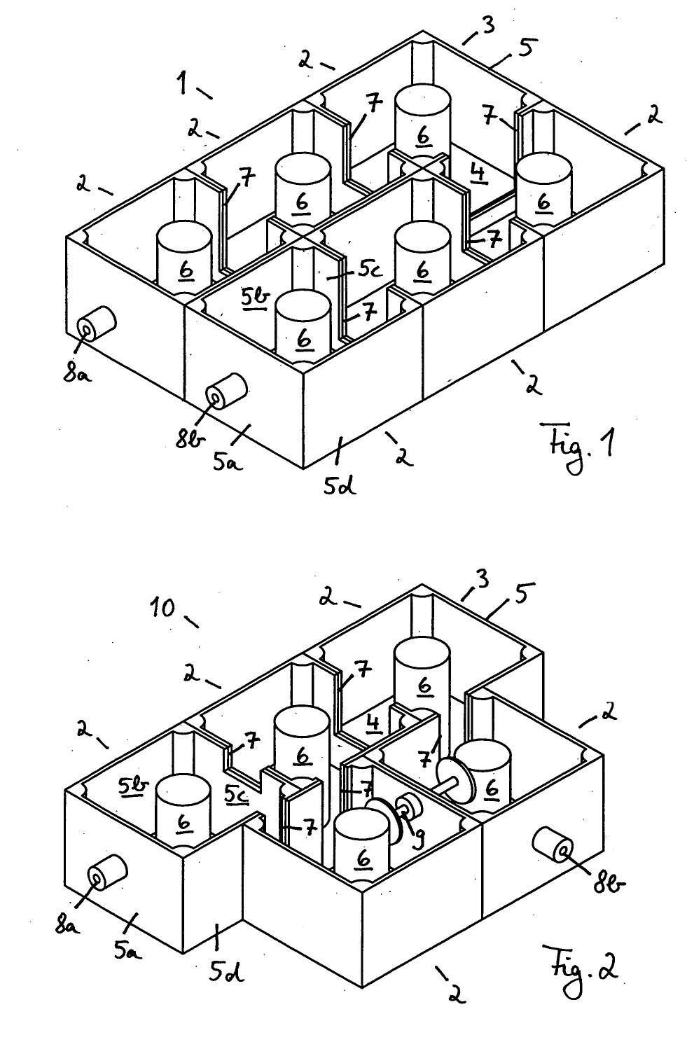

FIG. 1 is a schematic perspective view of a microwave filter comprising a plurality of coupled coaxial resonators.

FIG. 2 is a schematic perspective view of a further microwave filter comprising a plurality of coupled coaxial resonators.

In FIG. 1, a microwave filter 1 is shown. The filter 1 comprises six coaxial separate resonators 2 which are coupled together in a two-dimensional array. Each of the resonators 2 comprises a hollow housing 3, which is open at the top and is constituted by a rectangular bottom wall 4 and a sidewall 5 extending upwardly from the bottom wall 4. The sidewall 5 comprises four interconnected wall sections 5a, 5b, 5c, and 5d arranged at the four sides of the rectangular bottom wall 4 to laterally encircle the bottom wall 4. The housings 3 are formed integrally as a unitary structure. In the finished filter, a cover plate (not shown) is secured to the upper end of the sidewalls 5 to close the open top of the housings 3 of the resonators 2.

For reasons of weight and costs, the housings 2 are preferably composed of aluminum. However, they may also advantageously be composed of iron, copper, brass or Invar. Further advantageous choices of materials include ceramic materials or polymer materials. Advantageous polymer materials include polymer materials having good dimensional stability such as glass fiber reinforced polymer materials or other fiber reinforced polymer materials. It is only important that the resonators 2 can be produced in a cost-efficient manner and that the material is a good conductor or is plated with a good conducting material such as silver. While the filter of the present embodiment only includes coaxial resonators, it is to be noted that for other types of resonators, such as dielectric resonators or cavity resonators, the housings would preferably likewise be composed of the materials indicated above.

Each resonator 2 further comprises a cylindrical inner conductor 6 centrally attached at its lower end to the bottom wall 4 of the housing 3. The inner conductors 6 extend upwardly from the bottom wall 4 along the longitudinal axis of the respective housing 3. The length of the inner conductors 6 is lower than the length of the housings 3 so that a capacitive gap is formed between the upper end of the inner conductors 6 and the cover plate (not shown) used to close the open top of the housings 3. The inner conductors 6 are preferably composed of the same material as the housing 3 to which they are connected so that the housing 3 and the inner conductor 6 of a resonator 2 can advantageously be integrally produced in one piece. However, the inner conductors 6 can also be provided as separate elements. In this case, they are preferably composed of aluminum, iron, copper, brass, Invar, a polymer material or a ceramic material, or they may be composite components comprising two or more of these materials. Advantageous polymer materials include polymer materials having good dimensional stability such as glass fiber reinforced polymer materials or other fiber reinforced polymer materials. Again, it is only important that the resonators 2 can be produced in a cost-efficient manner and that the material is a good conductor or is plated with a good conducting material such as silver.

The six resonators 2 are mechanically connected side by side in a two-dimensional array by means of soldering or brazing. To achieve coupling between the resonators 2, a plurality of coupling windows 7 is provided in the sidewalls 5 of the resonators 2 by cutting. The resonators 2 are arranged such that coupling windows 7 of identical dimensions are aligned with respect to each other to form an opening in the sidewalls 5 separating two adjacent resonators 2. Such coupling windows 7 in the sidewalls 5 essentially provide for inductive coupling.

The field in the filter 1 is excited and extracted by means of suitable coupling means 8a and 8b, respectively, which may e.g. comprise an aperture or a coupling loop. In this embodiment, there is only one possible path for the electromagnetic field from the input coupling means 8a to the output coupling means 8b, i.e. there is no cross coupling.

In FIG. 2, a further embodiment of a microwave filter according to the invention is shown. The filter 10 comprises five coaxial resonators 2 which are coupled together in a two-dimensional array and which are identical to the resonators 2 of the first embodiment. Unlike the filter 1 of the first embodiment, the filter 10 does not only comprise coupling windows 7, but also a coupling probe 11. This coupling probe 11 is inserted into small openings which have been cut into the sidewalls 5 of adjacent resonators 2 and have been aligned with respect to each other. The coupling probe 11 provides for capacitive coupling.

Moreover, there is more than one possible path for the electromagnetic field to travel from the input coupling means 8a to the output coupling means 8b, i.e. there is cross coupling. This is advantageous because the filter performance can be improved in various ways by the introduction of cross couplings.

1. A method of constructing a microwave filter comprising a plurality of coupled resonators, the method comprising the steps of:
providing a plurality of individual resonators and
mechanically connecting the plurality of resonators to form the filter, characterized in that
each of the plurality of resonators is formed in one piece at least with a bottom wall and a sidewall laterally encircling the bottom wall and extending upwardly therefrom, and in that
the method further comprises the step of providing a plurality of coupling means between the individual resonators.

2. The method according to claim 1, wherein the plurality of resonators includes coaxial resonators, dielectric resonators and/or cavity resonators.

3. The method according to claim 1, wherein the step of providing the plurality of resonators includes the step of forming at least some resonators of the plurality of resonators by means of cold extrusion.

4. The method according to claim 1, wherein the resonators are formed such that the thickness of the sidewalls is 0.5-0.8 mm.

5. The method according to claim 1, wherein the step of providing the plurality of resonators includes the step of coating at least some resonators of the plurality of resonators with a metallic conductor layer.

6. The method according to claim 5, wherein the coating is performed with silver.

7. The method according to claim 1, wherein the coupling means include coupling loops, coupling irises, coupling windows and/or coupling probes.

8. The method according to claim 1, wherein the resonators are coupled in a two- or a three-dimensional array.

9. The method according to claim 1, wherein the resonators are coupled such that there is cross coupling between at least two of the resonators.

10. The method according to claim 1, wherein the coupling means are provided prior to mechanically connecting the resonators.

11. The method according to claim 1, wherein the coupling means are provided after mechanically connecting the resonators.

12. The method according to claim 1, wherein the resonators are mechanically connected by soldering or brazing.

13. A microwave filter manufactured by the method claimed in claim 1, the filter comprising a plurality of coupled resonators mechanically connected to form the filter, characterized in that
each of the plurality of resonators is formed separately in one piece at least with a bottom wall and a sidewall laterally encircling the bottom wall and extending upwardly therefrom, and in that
a plurality of coupling means is provided between the individual resonators.

14. The microwave filter according to claim 13, wherein the plurality of resonators includes coaxial resonators, dielectric resonators and/or cavity resonators.

15. The microwave filter according to claim 13, wherein at least some resonators of the plurality of resonators are formed by means of cold extrusion.

16. The microwave filter according to claim 13, wherein the thickness of the sidewalls of the resonators is 0.5-0.8 mm.

17. The microwave filter according to claim 13, wherein at least some resonators of the plurality of resonators are coated with a metallic conductor layer.

18. The microwave filter according to claim 17, wherein the coating is a silver coating.

19. The microwave filter according to claim 13, wherein the coupling means include coupling loops, coupling irises, coupling windows and/or coupling probes.

20. The microwave filter according to claim 13, wherein the resonators are coupled in a two- or a three-dimensional array.

21. The microwave filter according to claim 13, wherein the resonators are coupled such that there is cross coupling between at least two of the resonators.

22. The microwave filter according to claim 13, wherein the resonators are mechanically connected by soldering or brazing.
